(19) United States
(12) Patent Application Publication
(10) Pub. No.: US 2026/0262045 A1
(43) Pub. Date: Sep. 3, 2026

(54) USER EQUIPMENT CONFIGURATION FOR DIFFERENT DEVICE TYPE MODES

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/067,800

(22) Filed: Feb. 28, 2025

(51) Int. Cl. H04W 72/23; H04W 52/02; H04W 68/02

(52) U.S. Cl. CPC H04W 72/23; H04W 52/0235; H04W 68/02

(57) ABSTRACT

Various aspects of the present disclosure relate to user equipment (UE) configuration for different device type modes. A UE may determine, from configured modes of operation, a mode of operation for a type of the UE based on a coverage area of the UE in an idle and connected mode. The more of the configured modes of operation are configured for different coverage enhancement levels. The UE may monitor at least one of a paging occasion (PO) in a paging cycle or a physical downlink control channel (PDCCH) monitoring occasion according to the mode of operation for the type of the UE.

### TECHNICAL FIELD

The present disclosure relates to wireless communications, and more specifically to user equipment (UE) configuration for different device type modes.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to determine, from configured modes of operation, a mode of operation for a type of the UE based on a coverage area of the UE in an idle and connected mode, where one or more of the configured modes of operation are configured for different coverage enhancement levels; and monitor at least one of a paging occasion (PO) in a paging cycle or a physical downlink control channel (PDCCH) monitoring occasion according to the mode of operation for the type of the UE.

A processor (e.g., a standalone processor chipset, or a component of a UE) for wireless communication is described. The processor may be configured to, capable of, or operable to perform one or more operations as described herein. For example, the processor may be configured to, capable of, or operable to determine, from configured modes of operation, a mode of operation for a device type of a UE based on a coverage area of the UE in an idle and connected mode, where one or more of the configured modes of operation are configured for different coverage enhancement levels; and monitor at least one of a PO in a paging cycle or a PDCCH monitoring occasion according to the mode of operation for the type of the UE.

A method performed or performable by a UE for wireless communication is described. The method may include determining, from configured modes of operation, a mode of operation for a type of the UE based on a coverage area of the UE in an idle and connected mode, where one or more of the configured modes of operation are configured for different coverage enhancement levels; and monitoring at least one of a PO in a paging cycle for a PDCCH monitoring occasion according to the mode of operation for the type of the UE.

In some implementations of the UE, the processor, and the method described herein, the UE, the processor, and the method may be configured to, capable of, or operable to configure the configured modes of operation for the type of the UE. In some implementations of the UE, the processor, and the method described herein, the UE, the processor, and the method may be configured to, capable of, or operable to receive, from an NE, the configured modes of operation for the type of the UE. In some implementations of the UE, the processor, and the method described herein, the configured modes of operation include at least one or more of a first mode of operation for the type of the UE enabled for enhanced mobile broadband (eMBB); or a second mode of operation for the type of the UE configured as an Internet-of-things (IoT) low power wide area network (LPWA) device.

In some implementations of the UE, the processor, and the method described herein, the type of the UE enabled for eMBB is associated with a first coverage enhancement level; and the type of the UE configured as the IoT LPWA is associated with at least a second coverage enhancement level. In some implementations of the UE, the processor, and the method described herein, the second coverage enhancement level for the IoT LPWA is greater than the first coverage enhancement level for the eMBB. In some implementations of the UE, the processor, and the method described herein, to monitor the PO in the paging cycle, the UE, the processor, and the method may be configured to, capable of, or operable to monitor an IoT-PO associated with the at least second coverage enhancement level. In some implementations of the UE, the processor, and the method described herein, to monitor the PO in the paging cycle, the UE, the processor, and the method may be configured to, capable of, or operable to monitor an eMBB-PO associated with the first coverage enhancement level.

An NE (e.g., a base station (BS)) for wireless communication is described. The NE may be configured to, capable of, or operable to perform one or more operations as described herein. For example, the NE may be configured to, capable of, or operable to determine a mode of operation for a device type of a UE, where the mode of operation is determinable from one or more configured modes of operation for different coverage enhancement levels; and transmit, to the UE, a paging message based on the mode of operation for the type of the UE and a coverage area of the UE.

A processor (e.g., a standalone processor chipset, or a component of an NE) for wireless communication is described. The processor may be configured to, capable of, or operable to perform one or more operations as described herein. For example, the processor may be configured to, capable of, or operable to determine a mode of operation for a device type of a UE, where the mode of operation is determinable from one or more configured modes of operation for different coverage enhancement levels; and transmit, to the UE, a paging message based on the mode of operation for the type of the UE and a coverage area of the UE.

A method performed or performable by an NE (e.g., a BS) for wireless communication is described. The method may include determining a mode of operation for a device type of a UE, where the mode of operation is determinable from one or more configured modes of operation for different coverage enhancement levels; and transmitting, to the UE, a paging message based on the mode of operation for the type of the UE and a coverage area of the UE.

In some implementations of the NE, the processor, and the method described herein, to determine the mode of operation for the type of the UE, the NE, the processor, and the method may be configured to, capable of, or operable to transmit, to the UE, the paging message in a first PO associated with a first mode of operation for the type of the UE configured as an IoT LPWA device; monitor for a random access channel (RACH) to be received from the UE; and transmit, to the UE based on a lack of the RACH received from the UE, an additional paging message in a second PO associated with a second mode of operation for the type of the UE enabled for eMBB.

In some implementations of the NE, the processor, and the method described herein, to determine the mode of operation for the type of the UE, the NE, the processor, and the method may be configured to, capable of, or operable to transmit, to the UE, the paging message in a first PO associated with a first mode of operation for the type of the UE enabled for eMBB; monitor for a RACH to be received from the UE; and transmit, to the UE based on a lack of the RACH received from the UE, an additional paging message in a second PO associated with a second mode of operation for the type of the UE configured as an IoT LPWA device.

In some implementations of the NE, the processor, and the method described herein, to determine the configured mode of operation for the type of the UE, the NE, the processor, and the method may be configured to, capable of, or operable to transmit, to the UE, a first paging message in a first PO associated with a first mode of operation for the type of the UE enabled for eMBB; and transmit, to the UE, a second paging message in a second PO associated with a second mode of operation for the type of the UE configured as an IoT LPWA device.

In some implementations of the NE, the processor, and the method described herein, to determine the configured mode of operation for the type of the UE, the NE, the processor, and the method may be configured to, capable of, or operable to receive, from the UE, a RACH that indicates a switching of the mode of operation for the type of the UE, where the mode of operation is a first mode of operation for the type of the UE enabled for eMBB, or a second mode of operation for the type of the UE configured as an IoT LPWA device.

### BRIEF DESCRIPTION OF THE DRAWINGS

FIG. 1 illustrates an example of a wireless communications system in accordance with aspects of the present disclosure.

FIG. 2 illustrates an example of UE configuration for different device type modes of operation to maintain connectivity, in accordance with aspects of the present disclosure.

FIG. 3 illustrates an example of UE connected mode configuration for different device type modes of operation, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

In a wireless communications system, a UE and an NE (e.g., a BS, gNB, network entity, or network node) may support wireless communication, including reception and/or transmission of wireless communication, using time-frequency resources. For example, the UE and the NE may support communicating signals (e.g., carrying control information, data, and/or the like). It should be understood that various terms may be used interchangeably with “communicating,” such as “signaling,” “transmitting,” “receiving,” “outputting,” “forwarding,” “relaying,” “retrieving,” “obtaining,” and so forth.

In some cases, NEs may expend substantial energy when transmitting synchronization signal blocks (SSBs), a PBCH that includes a master information block (MIB), a system information block 1 (SIB1), as well as other system information (SI) and paging messages. In some networks, such as a legacy 5G network, the SIBs (other than SIB1, can be provided on-demand. The communication of SSB and SIB1 may be useful for cell identification, as well as for idle and connected mode mobility. However, continuous paging transmissions can result in unnecessary energy consumption, particularly if a few or none of the UEs being paged are present in a serving cell, where energy conservation is a priority.

Aspects of the present disclosure relate to enabling network energy saving by supporting efficient switching between different types of UE operation modes, including modes implemented for eMBB and IoT devices, such as IoT LPWA devices. In some cases, a 6G network (e.g., a wireless communications system) may be deployed to support both eMBB and IoT UEs, including IoT LPWA UEs. The 6G air interface design can be unified for a single serving cell and single radio access technology (RAT), which can support multiple types of UEs, such as eMBB, IoT, and/or IoT LPWA.

Aspects of the present disclosure are described in the context of a wireless communications system.

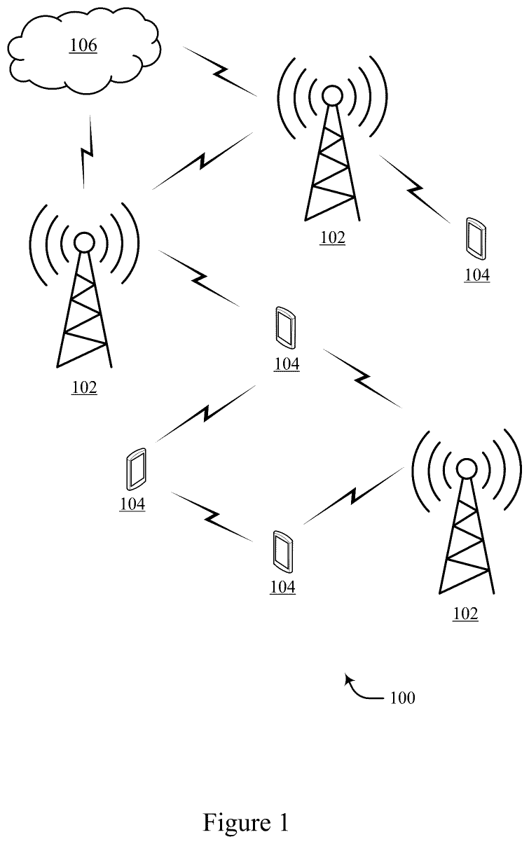

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a BS, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may enable network energy saving by implementing efficient transmission of the common channels and/or SI signaling for different UE device types. In some cases, a 6G network (e.g., a wireless communications system) may be implemented for both eMBB and IoT devices, such as IoT LPWA devices. The 6G air interface design can be unified for a single serving cell and single RAT, which can support multiple UE device types, such as eMBB, IoT, and/or IoT LPWA. Network energy savings may be realized with on-demand transmission of common channels and/or signals. Given that most of the network power consumption occurs in RAN, the transmit and reception times may be optimized to conserve as much power as possible. For example, IoT sensor data can be scheduled during non-peak hours, such as when the serving cell load for UE eMBB devices is minimal. With the network energy savings, IoT sensor data can be transmitted during active time periods of the serving cell, and the network avoids temporal scheduling of IoT data, prioritizing frequency division multiplexing (FDM) or code division multiplexing (CDM) of the IoT data to avoid long active time periods.

According to implementations, one or more of the NEs 102 and the UEs 104 are operable to implement various aspects of the techniques described with reference to the present disclosure. For example, a UE 104 determines, from configured modes of operation, a mode of operation for a type of the UE based on a coverage area of the UE in an idle and connected mode. One or more of the configured modes of operation are configured for different coverage enhancement levels. The UE 104 monitors at least one of a PO in a paging cycle or a PDCCH monitoring occasion according to the mode of operation for the type of the UE. An NE 102 (e.g., a BS, gNB) determines a mode of operation for a device type of a UE 104, where the mode of operation is determinable from one or more configured modes of operation for different coverage enhancement levels. The NE 102 transmits, to the UE 104, a paging message based on the mode of operation for the type of the UE and a coverage area of the UE.

With reference to network energy savings, emissions and energy consumption by the various devices of a wireless communications system (e.g., a telecommunication system) may adversely contribute to the climate. Additionally, the operating expenses to implement and maintain a telecommunication service can be immense. In telecoms, a number of industry-specific factors rooted in countering rising network costs have further shaped efficiency efforts. A continued rise in mobile data traffic, combined with the rising costs of spectrum, capital investment, and ongoing RAN maintenance and upgrades, energy-saving measures in network operations are essential. 5G New Radio (NR) offers a significant energy-efficiency improvement per gigabyte over previous generations of mobility. However, new 5G use cases and the adoption of mm Wave utilizes more cell sites and antennas, which may lead to the prospect of a more efficient network that may result in higher emissions.

Overall, network energy saving is an important aspect for environmental sustainability, such as to reduce the environmental impact (e.g., greenhouse gas emissions), and for operational cost savings. As 5G is becoming pervasive across industries and geographical areas, handling more advanced services and applications requiring very high data rates (e.g., XR), networks are becoming denser, using more antennas, larger bandwidths, and more frequency bands. Energy consumption accounts for a significant energy cost of a mobile network. Most of the energy consumption occurs at the radio access network, and in particular, at the active antenna unit (AAU), with data centers and fiber transport accounting for a smaller share. The power consumption of a radio access can be split into two parts, for example, the dynamic part which is only consumed when data transmission or reception is occurring, and the static part which is energy consumed consistently to maintain the necessary operation of the radio access devices, even when the data transmission and reception is not occurring.

Development and study of a network energy consumption model continues, particularly for BSs, key performance indicators, (KPIs), an evaluation methodology, and to identify and study network energy savings techniques in targeted deployment scenarios. Developments take into consideration how to achieve more efficient operations dynamically and/or semi-statically, and a finer granularity adaptation of transmissions and/or receptions in one or more network energy saving techniques in time, frequency, spatial, and power domains, with potential support and/or feedback from UEs, as well as potential UE assistance information, and information exchange and/or coordination over network interfaces. Considerations include the potential network energy consumption gains, as well as assessing and balancing the impact on network and user performance (e.g., by evaluating KPIs, such as for spectral efficiency, capacity, user perceived throughput (UPT), latency, UE power consumption, complexity, handover performance, call drop rate, initial access performance, service level agreements (SLA) assurance related KPIs, etc.).

In some cases, NEs may expend substantial energy when transmitting SSBs, a PBCH that includes a MIB, a SIB1, as well as other SI and paging messages. In some networks, such as a legacy 5G network, the SIBs (other than SIB1, can be provided on-demand. The communication of SSB and SIB1 may be useful for cell identification, as well as for idle and connected mode mobility. However, continuous paging transmissions can result in unnecessary energy consumption, particularly if a few or none of the UEs being paged are present in a serving cell, where energy conservation is a priority.

Aspects of the present disclosure relate to enabling network energy saving by supporting efficient switching between different types of UE operation modes, including modes implemented for eMBB and IoT devices, such as IoT LPWA devices. In some cases, a 6G network (e.g., a wireless communications system) may be deployed to support both eMBB and IoT UEs, including IoT LPWA UEs. The 6G air interface design can be unified for a single serving cell and single radio access technology (RAT), which can support multiple types of UEs, such as eMBB, IoT, and/or IoT LPWA.

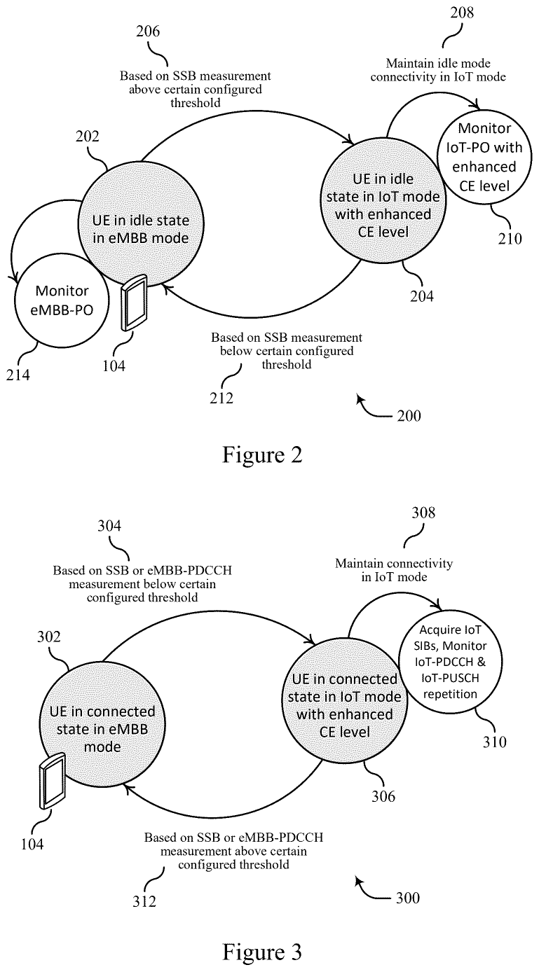

FIG. 2 illustrates an example 200 of UE configuration for different device type modes of operation to maintain connectivity, in accordance with aspects of the present disclosure. In one or more implementations, UEs supporting multiple device type modes of operation may switch from one mode of operation to another mode of operation depending on the coverage (i.e., signal strength to extend the coverage of operation, such as for transmit (Tx) and receive (Rx)) for common channels and signals, such as SSBs, required minimum SI, paging, and RACH. A UE 104 can support the multiple device type modes of operation (i.e., eMBB, and IoT LPWA), where an eMBB mode 202 of operation may have a maximum coupling loss (MCL) of 150 dB and an IoT mode 204 of operation may have a MCL of 164 dB. The UE 104 moving away from the cellular coverage area (e.g., 150 dB MCL) can maintain the idle mode operation, such as for paging, monitoring, etc., to receive an emergency notification, such as a voice call or messages from the serving cell by switching to the IoT mode 204 of operation when there is not a neighbor cell associated with the current cell while switching to the IoT mode of operation implies monitoring SSB, required minimum SI block, paging reception, and RACH transmission according to the IoT configuration enabling higher repetition to meet the enhanced coverage requirements. For example, the UE 104 can switch to the IoT mode 204 based on the SSB measurement above a certain configured threshold at 206. The enhanced coverage for an IoT LPWA mode of operation +15 dB to +20 dB from that of the eMBB coverage can be provided using coverage enhancement schemes, such as longer repetitions of the common channels and signals (i.e., the minimum SI using PBCH, SIB1, paging etc.).

The IoT LPWA supports 3~5 MHz of bandwidth which is approximately the same as that of the primary synchronization signal (PSS) or secondary synchronization signal (SSS) bandwidth, and supports enhanced MCL of up to 164 dB using a larger number of repetitions (e.g., 2000 repetitions) for physical uplink shared channel (PUSCH), 8 repetitions for PBCH, 16 repetitions for SIB1, etc. A UE 104 configured for eMBB (e.g., the UE in idle state in eMBB mode 202) may switch to the bandwidth part (BWP) of the IoT (e.g., the UE in idle state in IoT mode 204), or may reduce the initial BWP to 3~5 MHz of bandwidth. With reference to IoT LPWA coverage in comparison to eMBB coverage, the coverage enhancement level 0 is the same (or approximately the same) coverage as for eMBB, the coverage enhancement level 1 is +10 dB (e.g., repetitions X), and the coverage enhancement level 2 is +20 dB (e.g., repetitions Y. (Y>X)).

In one or more implementations, a UE 104 can support both device type modes of operation, and maintain idle mode connectivity to a cell (at 202), while determining that there is no neighbor cell associated with the current cell and the serving cell quality falls below a certain threshold. The UE 104 may switch the device type mode of operation from eMBB at 202 to the IoT mode of operation at 204, and at 208, maintain the idle mode connectivity in the IoT configuration to monitor the IoT common channels and signals (at 210), such as IoT PBCHs, SIB1, and PO providing enhanced coverage. In an implementation, the UE 104 may switch the device type mode of operation by transmitting a RACH preamble on a dedicated RACH resource configured to inform the BS (e.g., gNB, an NE) about the mode of operation switch. The BS can configure a dedicated RACH resource occasion to a UE configured in SIB1, and the UE may transmit RACH when the reference signal received power (RSRP) of SSB is below a certain configured threshold (at 212), informing the BS that the UE may monitor for the IoT paging channel, and the BS can page the UE in the IoT paging channel instead of paging it in the eMBB paging channel (at 214). The IoT paging channel may have paging occasions with larger repetitions to provide a paging message for deep coverage.

In an implementation, the BS (e.g., gNB, an NE) after transmitting a paging message in the eMBB paging occasion, the BS (e.g., gNB, an NE) may start a timer while the duration of the timer is longer than the SSB-RACH association period to enable the reception of RACH from the paged UE. If the BS does not receive a RACH within the time expiry of the time, the BS may transmit the page in the IoT paging channel. In other implementations, the BS may transmit the page for a UE in both the eMBB and IoT paging occasions, if the UE supports both device types of operation modes. In implementations, there may be separate paging occasions configured for the eMBB and IoT LPWA, and the paging cycle can be semi-statically configurable separately for eMBB and IoT. The number of paging records transmitted by a RRC paging message in a paging occasion can be separately defined for eMBB and IoT. For example, the RRC paging record for eMBB can be fixed up to 32, while for IoT can be fixed to 1 or 2 due to the physical resource blocks needed to transmit IoT paging messages that are to be within the bandwidth of the IoT device type.

However, the paging occasions for each UE eMBB device can be defined in a FDM manner within the eMBB paging frame in an eMBB paging cycle. Similarly, FDM paging occasions for each IoT device can be defined in a FDM manner, where each FDM paging occasion may be configured to transmit 1 or 2 paging records within the bandwidth of the IoT devices in the IoT paging frame in an IoT paging cycle. The paging bursts within a paging frame of a paging cycle can be implemented for time domain multiplexing of contiguous paging occasions, which can be separately defined for eMBB and IoT device types. The paging cycle of UE eMBB devices and UEs as IoT devices can be separately configured, while the eMBB paging cycle can be shorter compared to the paging time window of an IoT UE different discontinuous reception (DRX) cycle period between them (i.e., for a different traffic arrival pattern and battery saving possibility). An extended DRX cycle of IoT may be approximately 10.34 seconds, while the eMBB DRX cycle may be approximately 1.24 seconds. The paging cycle of an IoT UE can be an integer multiple of the paging cycle of eMBB, and there may be an overlap of paging occasions between them. In case of a lesser paging rate, implying one paging record transmission in a paging occasion and/or to conserve network energy savings, the paging record (i.e., 5G-s-TMSI value, establishment cause etc.) can also be indicated in the paging DCI payload content, which means there was no PDSCH associated with this paging DCI. When a paging record is sent in the DCI payload, then a UE may not monitor for the associated PDSCH, and the time-frequency resource assignment field can be ignored or filled with invalid values.

With reference to a BS (e.g., gNB, an NE) determining that a UE has switched the device type mode of operation, in an implementation, the BS may transmit the paging message in the first device type mode of operation (e.g., eMBB paging occasion) and when the BS does not receive a RACH (e.g., as a response) from the UE, then the BS may send the paging message for the second device type mode of operation (e.g., IoT paging occasions). However, the UE may switch the device type mode of operation to monitor the respective paging occasions based on the reception signal strength of SSB. In another implementation, the UE is registered as being able to support both device type modes of operation (i.e., eMBB and IoT), and the BS may page the UE in both paging occasions. In another implementation, a separate RACH resource may be configured, indicating a switch of the device type mode of operation. Hence, the UE may transmit a RACH to the BS indicating the switch of the mode of operation, and the BS can then determine which paging occasion to be used to send the paging message to the UE.

With reference to switching between a transport network (TN) and an NTN with IoT, a UE may enter the IoT mode of operation with NTN when there is no neighbor TN cell associated with the current TN cell, such as when the received signal strength from the current TN cell SSBs falls below the configured threshold. In another implementation, the UE may switch to the NTN IoT mode of operation from the TN IoT mode of operation when the signal strength of the TN SSB falls below configured threshold. The UE may receive the common channels and signals from the NTN cell, as explained in the previous examples.

FIG. 3 illustrates an example 300 of UE connected mode configuration for different device type modes of operation, in accordance with aspects of the present disclosure. With reference to UEs that support multiple device type modes of operation, a UE 104 in a connected mode at 302 may switch the device type mode of operation (at 304) based on the SSB or PDCCH reception signal strength. The UE 104 may switch to the IoT connected IoT mode at 306 with a bandwidth of 3~5 MHz, and certain logical channels restrictions may be applied, such as the high priority, low data rate for voice calls, and messaging logical channels can be prioritized in the IoT mode 306 while the logical channels with a high data rate or low priority can be de-prioritized. The UE 104 may apply increased repetitions for the transmission of a PUSCH or physical uplink control channel (PUCCH) channel, depending on the coverage enhancement levels. The UE may monitor for the IoT-PDCCH after switching to the IoT mode of operation in the connected mode when the UE's signal strength from eMBB-PDCCH or SSBs falls below a certain threshold and there is no neighbor cell to perform handover. The IoT-PDCCH offers deeper coverage using higher repetition and UEs can be configured to monitor IoT-PDCCH DCI sizes or formats or search spaces accordingly. The IoT mode of configuration can be a fallback operational configuration provided to the UE. In the case of separate IoT and eMBB UEs in the coverage of a BS, the BS may configure IoT devices to use the same paging occasion, RACH occasions as that of the eMBB UE, or can have separate eMBB or IoT occasions. From the UE in the connected state in the IoT mode at 306, the UE can maintain connectivity (at 308) in the IoT mode, as well as acquire IoT SIBs and monitor IoT-PDCCH and IoT-PUSCH repetition at 310. Additionally, or alternatively from the UE in the connected state in the IoT mode at 306, the UE can switch (at 312) to the connected state in eMBB mode at 302, such as based on SSB or eMBB-PDCCH measurement above a certain configured threshold.

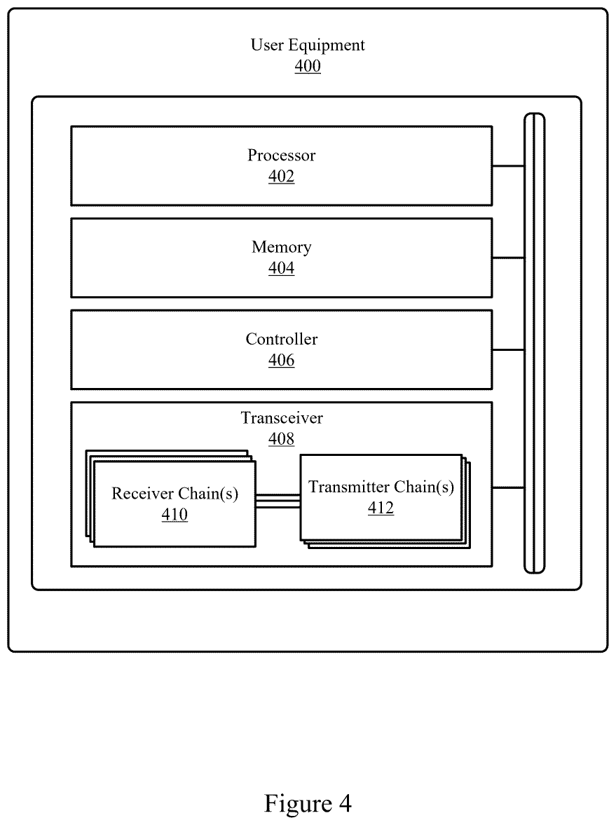

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to or operable to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for determining, from configured modes of operation, a mode of operation for a type of the UE based on a coverage area of the UE in an idle and connected mode, where one or more of the configured modes of operation are configured for different coverage enhancement levels; and monitoring at least one of a PO in a paging cycle for a PDCCH monitoring occasion according to the mode of operation for the type of the UE.

Additionally, the UE 400 may be configured to or operable to support any one or combination of the method further including at least one of configuring the configured modes of operation for the type of the UE; or receiving, from an NE, the configured modes of operation for the type of the UE. The configured modes of operation include at least one or more of a first mode of operation for the type of the UE enabled for eMBB; or a second mode of operation for the type of the UE configured as an IoT LPWA device. The type of the UE enabled for eMBB is associated with a first coverage enhancement level; and the type of the UE configured as the IoT LPWA is associated with at least a second coverage enhancement level. The second coverage enhancement level for the IoT LPWA is greater than the first coverage enhancement level for the eMBB. To monitor the PO in the paging cycle, the method further including at least one of monitoring an IoT-PO associated with the at least second coverage enhancement level; or monitoring an eMBB-PO associated with the first coverage enhancement level.

Additionally, or alternatively, the UE 400 may support at least one memory (e.g., the memory 404) and at least one processor (e.g., the processor 402) coupled with the at least one memory and configured to or operable to cause the UE to determine, from configured modes of operation, a mode of operation for a type of the UE based on a coverage area of the UE in an idle and connected mode, where one or more of the configured modes of operation are configured for different coverage enhancement levels; and monitor at least one of a PO in a paging cycle or a PDCCH monitoring occasion according to the mode of operation for the type of the UE.

Additionally, the UE 400 may be configured to or operable to support any one or combination of the at least one processor is operable to cause the UE to configure the configured modes of operation for the type of the UE. The at least one processor is operable to cause the UE to receive, from an NE, the configured modes of operation for the type of the UE. The configured modes of operation include at least one or more of a first mode of operation for the type of the UE enabled for eMBB; or a second mode of operation for the type of the UE configured as an IoT LPWA device. The type of the UE enabled for eMBB is associated with a first coverage enhancement level; and the type of the UE configured as the IoT LPWA is associated with at least a second coverage enhancement level. The second coverage enhancement level for the IoT LPWA is greater than the first coverage enhancement level for the eMBB. To monitor the PO in the paging cycle, the at least one processor is operable to cause the UE to monitor an IoT-PO associated with the at least second coverage enhancement level. To monitor the PO in the paging cycle, the at least one processor is operable to cause the UE to monitor an eMBB-PO associated with the first coverage enhancement level.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

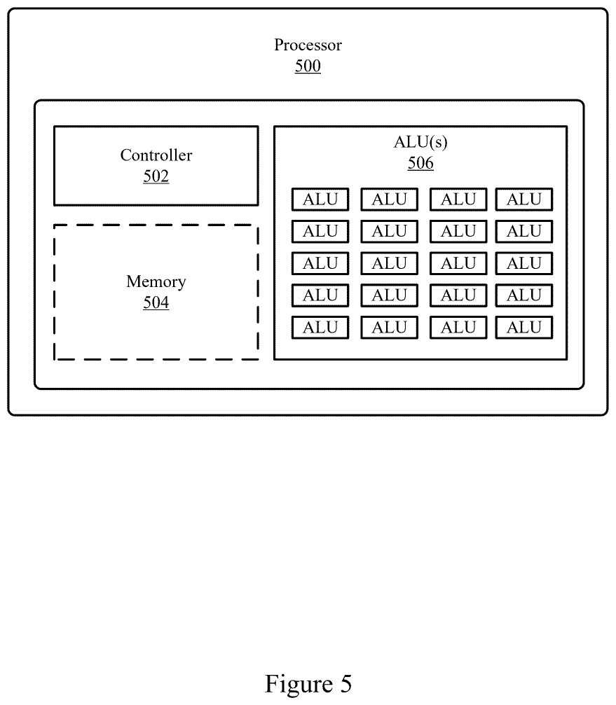

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to support at least one controller (e.g., the controller 502) coupled with at least one memory (e.g., the memory 504) and configured to or operable to cause the processor to determine, from configured modes of operation, a mode of operation for a device type of a UE based on a coverage area of the UE in an idle and connected mode, where one or more of the configured modes of operation are configured for different coverage enhancement levels; and monitor at least one of a PO in a paging cycle or a PDCCH monitoring occasion according to the mode of operation for the type of the UE.

Additionally, the processor 500 may be configured to or operable to support any one or combination of the at least one processor is operable to cause the UE to configure the configured modes of operation for the type of the UE. The at least one processor is operable to cause the UE to receive, from an NE, the configured modes of operation for the type of the UE. The configured modes of operation include at least one or more of a first mode of operation for the type of the UE enabled for eMBB; or a second mode of operation for the type of the UE configured as an IoT LPWA device. The type of the UE enabled for eMBB is associated with a first coverage enhancement level; and the type of the UE configured as the IoT LPWA is associated with at least a second coverage enhancement level. The second coverage enhancement level for the IoT LPWA is greater than the first coverage enhancement level for the eMBB. To monitor the PO in the paging cycle, the at least one processor is operable to cause the UE to monitor an IoT-PO associated with the at least second coverage enhancement level. To monitor the PO in the paging cycle, the at least one processor is operable to cause the UE to monitor an eMBB-PO associated with the first coverage enhancement level.

The processor 500 may support wireless communication in accordance with examples as disclosed herein. The processor 500 may be configured to support at least one controller (e.g., the controller 502) coupled with at least one memory (e.g., the memory 504) and configured to or operable to cause the processor to determine a mode of operation for a device type of a UE, where the mode of operation is determinable from one or more configured modes of operation for different coverage enhancement levels; and transmit, to the UE, a paging message based on the mode of operation for the type of the UE and a coverage area of the UE.

Additionally, the processor 500 may be configured to or operable to support any one or combination of to determine the mode of operation for the type of the UE, the at least one controller is operable to cause the processor to transmit, to the UE, the paging message in a first PO associated with a first mode of operation for the type of the UE configured as an IoT LPWA device; monitor for a RACH to be received from the UE; and transmit, to the UE based on a lack of the RACH received from the UE, an additional paging message in a second PO associated with a second mode of operation for the type of the UE enabled for eMBB. To determine the mode of operation for the type of the UE, the at least one controller is operable to cause the processor to transmit, to the UE, the paging message in a first PO associated with a first mode of operation for the type of the UE enabled for eMBB; monitor for a RACH to be received from the UE; and transmit, to the UE based on a lack of the RACH received from the UE, an additional paging message in a second PO associated with a second mode of operation for the type of the UE configured as an IoT LPWA device. To determine the configured mode of operation for the type of the UE, the at least one controller is operable to cause the processor to transmit, to the UE, a first paging message in a first PO associated with a first mode of operation for the type of the UE enabled for eMBB; and transmit, to the UE, a second paging message in a second PO associated with a second mode of operation for the type of the UE configured as an IoT LPWA device. To determine the configured mode of operation for the type of the UE, the at least one controller is operable to cause the processor to receive, from the UE, a RACH that indicates a switching of the mode of operation for the type of the UE, where the mode of operation is a first mode of operation for the type of the UE enabled for eMBB, or a second mode of operation for the type of the UE configured as an IoT LPWA device.

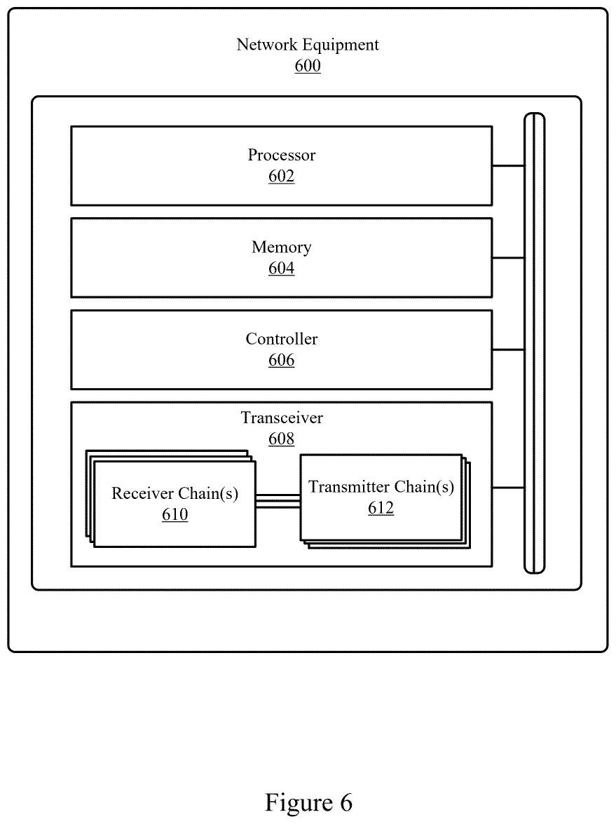

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for determining a mode of operation for a device type of a UE, where the mode of operation is determinable from one or more configured modes of operation for different coverage enhancement levels; and transmitting, to the UE, a paging message based on the mode of operation for the type of the UE and a coverage area of the UE.

Additionally, the NE 600 may be configured to or operable to support any one or combination of to determine the mode of operation for the type of the UE, the method further including transmitting, to the UE, the paging message in a first PO associated with a first mode of operation for the type of the UE configured as an IoT LPWA device; monitoring for a RACH to be received from the UE; and transmitting, to the UE based on a lack of the RACH received from the UE, an additional paging message in a second PO associated with a second mode of operation for the type of the UE enabled for eMBB. To determine the mode of operation for the type of the UE, the method further including transmitting, to the UE, the paging message in a first PO associated with a first mode of operation for the type of the UE enabled for eMBB; monitoring for a RACH to be received from the UE; and transmitting, to the UE based on a lack of the RACH received from the UE, an additional paging message in a second PO associated with a second mode of operation for the type of the UE configured as an IoT LPWA device. To determine the configured mode of operation for the type of the UE, the method further including transmitting, to the UE, a first paging message in a first PO associated with a first mode of operation for the type of the UE enabled for eMBB; and transmitting, to the UE, a second paging message in a second PO associated with a second mode of operation for the type of the UE configured as an IoT LPWA device. To determine the configured mode of operation for the type of the UE, the method further including receiving, from the UE, a RACH that indicates a switching of the mode of operation for the type of the UE, where the mode of operation is a first mode of operation for the type of the UE enabled for eMBB, or a second mode of operation for the type of the UE configured as an IoT LPWA device.

Additionally, or alternatively, the NE 600 may support at least one memory (e.g., the memory 604) and at least one processor (e.g., the processor 602) coupled with the at least one memory and configured to or operable to cause the NE to determine a mode of operation for a device type of a UE, where the mode of operation is determinable from one or more configured modes of operation for different coverage enhancement levels; and transmit, to the UE, a paging message based on the mode of operation for the type of the UE and a coverage area of the UE.

Additionally, the NE 600 may be configured to or operable to support any one or combination of to determine the mode of operation for the type of the UE, the at least one processor is operable to cause the NE to transmit, to the UE, the paging message in a first PO associated with a first mode of operation for the type of the UE configured as an IoT LPWA device; monitor for a RACH to be received from the UE; and transmit, to the UE based on a lack of the RACH received from the UE, an additional paging message in a second PO associated with a second mode of operation for the type of the UE enabled for eMBB. To determine the mode of operation for the type of the UE, the at least one processor is operable to cause the NE to transmit, to the UE, the paging message in a first PO associated with a first mode of operation for the type of the UE enabled for eMBB; monitor for a RACH to be received from the UE; and transmit, to the UE based on a lack of the RACH received from the UE, an additional paging message in a second PO associated with a second mode of operation for the type of the UE configured as an IoT LPWA device. To determine the configured mode of operation for the type of the UE, the at least one processor is operable to cause the NE to transmit, to the UE, a first paging message in a first PO associated with a first mode of operation for the type of the UE enabled for eMBB; and transmit, to the UE, a second paging message in a second PO associated with a second mode of operation for the type of the UE configured as an IoT LPWA device. To determine the configured mode of operation for the type of the UE, the at least one processor is operable to cause the NE to receive, from the UE, a RACH that indicates a switching of the mode of operation for the type of the UE, where the mode of operation is a first mode of operation for the type of the UE enabled for eMBB, or a second mode of operation for the type of the UE configured as an IoT LPWA device.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

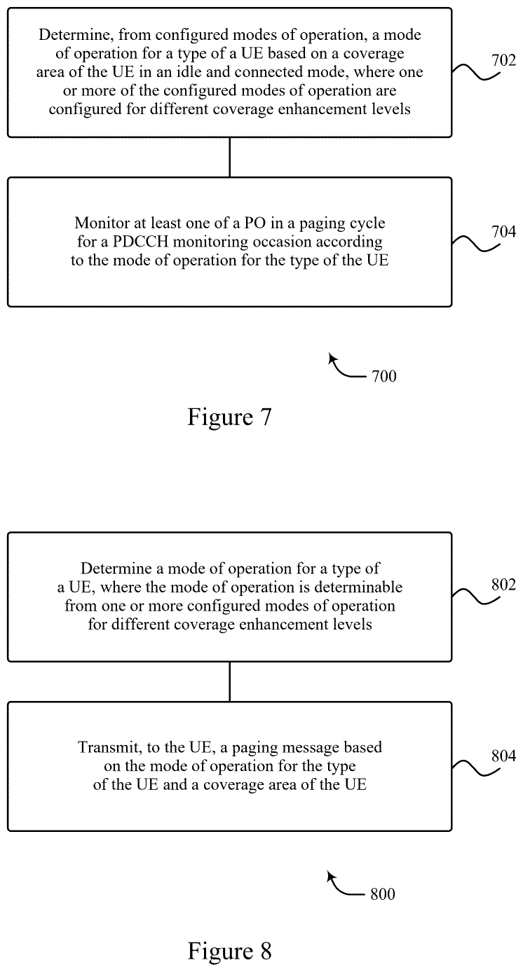

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include determining, from configured modes of operation, a mode of operation for a device type of a UE based on a coverage area of the UE in an idle and connected mode, where one or more of the configured modes of operation are configured for different coverage enhancement levels. The operations of 702 may be performed in accordance with examples as described herein. In some implementations, aspects of the operations of 702 may be performed by a UE as described with reference to FIG. 4.

At 704, the method may include monitoring at least one of a PO in a paging cycle for a PDCCH monitoring occasion according to the mode of operation for the type of the UE. The operations of 704 may be performed in accordance with examples as described herein. In some implementations, aspects of the operations of 704 may be performed by a UE as described with reference to FIG. 4.

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include determining a mode of operation for a device type of a UE, where the mode of operation is determinable from one or more configured modes of operation for different coverage enhancement levels. The operations of 802 may be performed in accordance with examples as described herein. In some implementations, aspects of the operations of 802 may be performed by an NE as described with reference to FIG. 6.

At 804, the method may include transmitting, to the UE, a paging message based on the mode of operation for the type of the UE and a coverage area of the UE. The operations of 804 may be performed in accordance with examples as described herein. In some implementations, aspects of the operations of 804 may be performed by an NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
determine, from configured modes of operation, a mode of operation for a type of the UE based at least in part on a coverage area of the UE in an idle and connected mode, wherein one or more of the configured modes of operation are configured for different coverage enhancement levels; and
monitor at least one of a paging occasion (PO) in a paging cycle or a physical downlink control channel (PDCCH) monitoring occasion according to the mode of operation for the type of the UE.

2. The UE of claim 1, wherein the at least one processor is operable to cause the UE to configure the configured modes of operation for the type of the UE.

3. The UE of claim 1, wherein the at least one processor is operable to cause the UE to receive, from a network equipment (NE), the configured modes of operation for the type of the UE.

4. The UE of claim 1, wherein the configured modes of operation include at least one or more of:
a first mode of operation for the type of the UE enabled for enhanced mobile broadband (eMBB); or
a second mode of operation for the type of the UE configured as an Internet-of-things (IoT) low power wide area network (LPWA) device.

5. The UE of claim 4, wherein:
the type of the UE enabled for eMBB is associated with a first coverage enhancement level; and
the type of the UE configured as the IoT LPWA is associated with at least a second coverage enhancement level.

6. The UE of claim 5, wherein the second coverage enhancement level for the IoT LPWA is greater than the first coverage enhancement level for the eMBB.

7. The UE of claim 5, wherein, to monitor the PO in the paging cycle, the at least one processor is operable to cause the UE to monitor an IoT-PO associated with the at least second coverage enhancement level.

8. The UE of claim 5, wherein, to monitor the PO in the paging cycle, the at least one processor is operable to cause the UE to monitor an eMBB-PO associated with the first coverage enhancement level.

9. A method performed by a user equipment (UE), the method comprising:
determining, from configured modes of operation, a mode of operation for a type of the UE based at least in part on a coverage area of the UE in an idle and connected mode, wherein one or more of the configured modes of operation are configured for different coverage enhancement levels; and
monitoring at least one of a paging occasion (PO) in a paging cycle for a physical downlink control channel (PDCCH) monitoring occasion according to the mode of operation for the type of the UE.

10. The method of claim 9, further comprising at least one of:
configuring the configured modes of operation for the type of the UE; or
receiving, from a network equipment (NE), the configured modes of operation for the type of the UE.

11. The method of claim 9, wherein the configured modes of operation include at least one or more of:
a first mode of operation for the type of the UE enabled for enhanced mobile broadband (eMBB); or
a second mode of operation for the type of the UE configured as an Internet-of-things (IoT) low power wide area network (LPWA) device.

12. The method of claim 11, wherein:
the type of the UE enabled for eMBB is associated with a first coverage enhancement level; and
the type of the UE configured as the IoT LPWA is associated with at least a second coverage enhancement level.

13. The method of claim 12, wherein the second coverage enhancement level for the IoT LPWA is greater than the first coverage enhancement level for the eMBB.

14. The method of claim 12, wherein, to monitor the PO in the paging cycle, the method further comprising at least one of:
monitoring an IoT-PO associated with the at least second coverage enhancement level; or
monitoring an eMBB-PO associated with the first coverage enhancement level.

15. A network equipment (NE) for wireless communication, comprising:
at least one memory; and
at least one processor coupled with the at least one memory and operable to cause the NE to:
determine a mode of operation for a device type of a user equipment (UE), wherein the mode of operation is determinable from one or more configured modes of operation for different coverage enhancement levels; and
transmit, to the UE, a paging message based at least in part on the mode of operation for the type of the UE and a coverage area of the UE.

16. The NE of claim 15, wherein, to determine the mode of operation for the type of the UE, the at least one processor is operable to cause the NE to:
transmit, to the UE, the paging message in a first paging occasion (PO) associated with a first mode of operation for the type of the UE configured as an Internet-of-things (IoT) low power wide area network (LPWA) device;
monitor for a random access channel (RACH) to be received from the UE; and
transmit, to the UE based on a lack of the RACH received from the UE, an additional paging message in a second PO associated with a second mode of operation for the type of the UE enabled for enhanced mobile broadband (eMBB).

17. The NE of claim 15, wherein, to determine the mode of operation for the type of the UE, the at least one processor is operable to cause the NE to:
transmit, to the UE, the paging message in a first paging occasion (PO) associated with a first mode of operation for the type of the UE enabled for enhanced mobile broadband (eMBB);
monitor for a random access channel (RACH) to be received from the UE; and
transmit, to the UE based on a lack of the RACH received from the UE, an additional paging message in a second PO associated with a second mode of operation for the type of the UE configured as an Internet-of-things (IoT) low power wide area network (LPWA) device.

18. The NE of claim 15, wherein, to determine the configured mode of operation for the type of the UE, the at least one processor is operable to cause the NE to:
transmit, to the UE, a first paging message in a first paging occasion (PO) associated with a first mode of operation for the type of the UE enabled for enhanced mobile broadband (eMBB); and
transmit, to the UE, a second paging message in a second PO associated with a second mode of operation for the type of the UE configured as an Internet-of-things (IoT) low power wide area network (LPWA) device.

19. The NE of claim 15, wherein, to determine the configured mode of operation for the type of the UE, the at least one processor is operable to cause the NE to receive, from the UE, a random access channel (RACH) that indicates a switching of the mode of operation for the type of the UE, wherein the mode of operation is a first mode of operation for the type of the UE enabled for enhanced mobile broadband (eMBB), or a second mode of operation for the type of the UE configured as an Internet-of-things (IoT) low power wide area network (LPWA) device.

20. A method performed by a network equipment (NE), the method comprising:
determining a mode of operation for a device type of a user equipment (UE), wherein the mode of operation is determinable from one or more configured modes of operation for different coverage enhancement levels; and
transmitting, to the UE, a paging message based at least in part on the mode of operation for the type of the UE and a coverage area of the UE.
